(19) United States
(12) Patent Application Publication
(10) Pub. No.: US 2018/0127069 A1
(43) Pub. Date: May 10, 2018

(54) KITE CONTROL BAR WITH BACK TRIM LINE TENSIONING MEANS USING A BAR END FLOAT

(71) Applicant: Ocean Rodeo Sports Inc., Victoria (CA)

(72) Inventors: Ross Davis HARRINGTON, Victoria (CA); Richard Kerr MYERSCOUGH, Victoria (CA)

(21) Appl. No.: 15/800,133

(22) Filed: Nov. 1, 2017

Related U.S. Application Data
(60) Provisional application No. 62/418,001, filed on Nov. 4, 2016.

(51) Int. Cl. B63B 35/79; B64C 31/06

(52) U.S. Cl. CPC B63B 35/7979; B64C 31/06

(57) ABSTRACT

A kite control bar having a tensioning bar end float which is capable of expanding and contracting. When an adjusting force is exerted upon the trim line, the trim line to backline leader connection pushes the bar end float from an expanded state to a contracted state. When the adjusting force is released, the bar end float tends to return to its expanded state. This ensures that constant tension is maintained on the trim line to prevent excess line from tangling inside the kite bar and bar end float while depowering.

### FIELD

The field of this innovation is a kite control bar used for kite boarding.

### BACKGROUND

Kite control bars that are used for kite boarding have front flying lines that connect to the leading edge of the kite and back flying line that connect to the wingtips of the kite near the trailing edge. By varying the length of the back flying lines in relation to the front flying lines the angle of attack of the kite can be adjusted. Lengthening the back flying lines will lower the angle of attack of the kite thus reducing the power that the kite can produce. Shortening the back flying lines will increase the angle of attack of the kite thus increasing the power that the kite can produce.

Trim systems can be integrated into the kite control bar so that the length of the back flying lines can be adjusted by the user. These trim systems can be, but not limited to, winders, winches, ropes and cleats and any other system that allows for the length of the back flying lines to be adjusted.

When the kite is in flight the front flying lines and back flying lines are under tension so when the trim system is adjusted to reduce the power in the kite, by lengthening the back flying lines, the excess back trim line that is inside the bar and bar end floats is pulled tight out of the top of the bar end float.

When the kite is not in flight it is important for the user to be able to set the trim of the kite, for more or less power, before launching the kite into the air. Launching the kite with the incorrect power trim setting could result in an accident. When reducing the power by lengthening the trim system, the excess back trim line is not pulled out of the end of the bar or bar end float, as the kite is not pulling on the back flying lines. So as a result of this, the excess back trim line gathers inside the kite control bar, bar end or bar end float. This can potentially cause the back trim line to tangle thus disabling the trim system. As the back trim line is not pulled out of the end of the bar or bar end float, the user is unable to tell exactly what the trim setting is before launching the kite.

### SUMMARY

There is provided a kite control bar having a bar end float through which a trim line passes. The bar end float provides a means of tensioning the interior trim line to ensure the line can be adequately pulled into and pushed out of the kite bar. The bar end float has a default state which is either an expanded state or a contracted state. When an adjusting force is exerted upon the trim line, the bar end float is drawn into another of the expanded state or the contracted state. When the adjusting force is released, bar end float tends to return to the default state. This biases the trim line to force excess trim line out of top portion of the bar end.

By enabling the bar end float to tension the trim line, it forces the excess back trim line out of the top of the bar end float. When there is no tension on the back flying lines from the kite, this will prevent excess back trim line from gathering inside the kite control bar and bar end float ends. Since the excess back trim line is forced out of the top of the bar end floats, the user is able to see and gauge the trim setting before launching the kite.

The bar end float can apply tension to the back trim line by compressing the foam bar end float.

The bar end float can also apply tension to the back trim line by compressing an chamber filled with any gas or liquid.

The bar end float can also apply tension to the back trim line by compressing a compression spring located below, inside or in place of the bar end float.

The bar end float can also apply tension to the back trim line by pushing two opposing pole magnets closer to one another.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a rear elevation view of a kite control bar with backline tensioning means through float compression in an expanded state.

FIG. 2 is a rear elevation view of a kite control bar with backline tensioning means through float compression in a contracted state.

FIG. 3 is a rear elevation view of a kite control bar with backline tensioning means through float compression in an expanded state.

FIG. 4 is a rear elevation view of a kite control bar with backline tensioning means through float compression in a contracted state.

FIG. 5 is a rear elevation view of a kite control bar with backline tensioning means through float compression in an expanded state.

FIG. 6 is a rear elevation view of a kite control bar with backline tensioning means through float compression in a contracted state.

FIG. 7 is a rear elevation view of a kite control bar with backline tensioning means through an inflatable bar float in an expanded state.

FIG. 8 is a rear elevation view of a kite control bar with backline tensioning means through an inflatable bar float in a contracted state.

FIG. 9 is a rear elevation view of a kite control bar with backline tensioning means through the use of a compression spring in an expanded state.

FIG. 10 is a rear elevation view of a kite control bar with backline tensioning means through the use of a compression spring in an expanded state.

FIG. 11 is a rear elevation view of a kite control bar with backline tensioning means through an inflatable bar end float, in an expanded state.

FIG. 12 is a rear elevation view of a kite control bar with backline tensioning means through an inflatable bar end float, in an expanded state.

FIG. 13 is a rear elevation view of a kite control bar with backline tensioning means through a covered compression spring, in place of a bar float.

FIG. 14 is a rear elevation view of a kite control bar with backline tensioning means through a covered compression spring, in place of a bar float.

FIG. 15 is a rear elevation view of a kite control bar with backline tensioning means through a covered compression spring, in place of a bar float.

FIG. 16 is a rear elevation view of a kite control bar with backline tensioning means through the use of a magnetic force line tensioning system, in an expanded state.

FIG. 17 is a rear elevation view of a kite control bar with backline tensioning means through the use of a magnetic force line tensioning system, in an expanded state.

### DETAILED DESCRIPTION

### Structure and Relationship of Parts:

In each embodiment, there is provided a kite control bar 2 having a hollow bar end float 4 through which a trim line 24 passes. The bar end float 4 provides a means of tensioning the trim line 24. The bar end float 4 is capable of expanding and contracting. The bar end float 4 has a default state which is either an expanded state or a contracted state. When an adjusting force upon trim line 24 draws the bar end float into the contracted state, the bar end float 4 will return to the expanded state when the force is released. The expansion of the bar end float exerts an upward force on the trim line to back line leader connection 16. Because of this, the end of trim line 24 and the top portion of the bar end 8 move together at all times. This ensures that a constant tension is maintained on the trim line 24 to prevent excess line from collecting inside the bar end float 4.

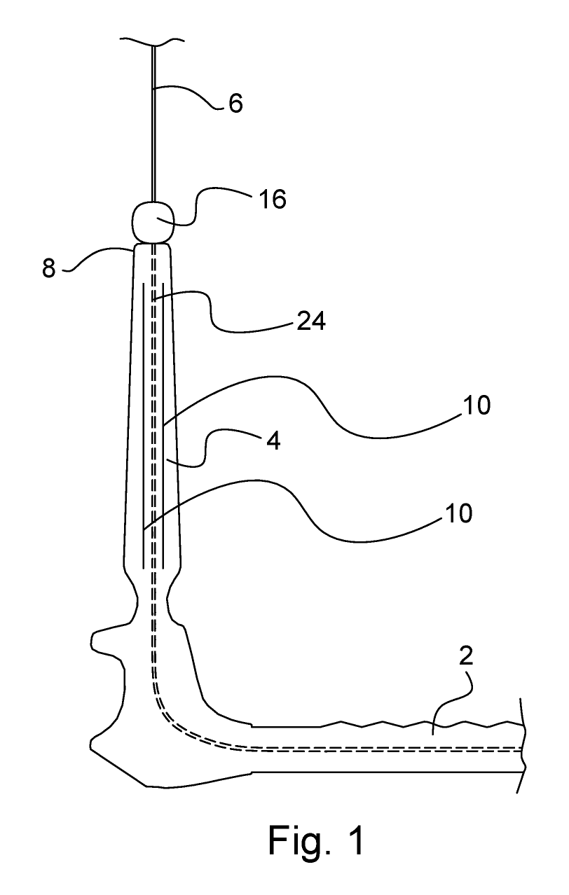

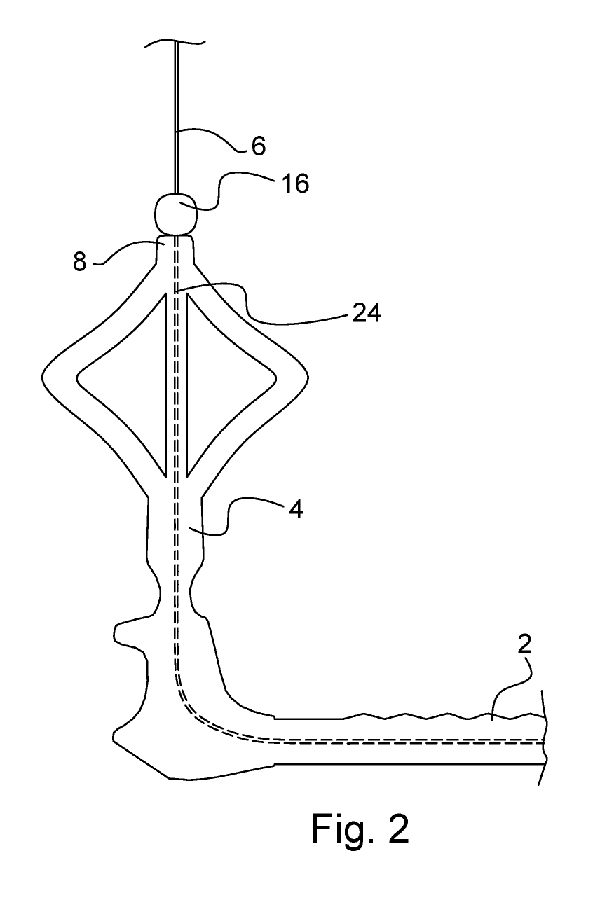

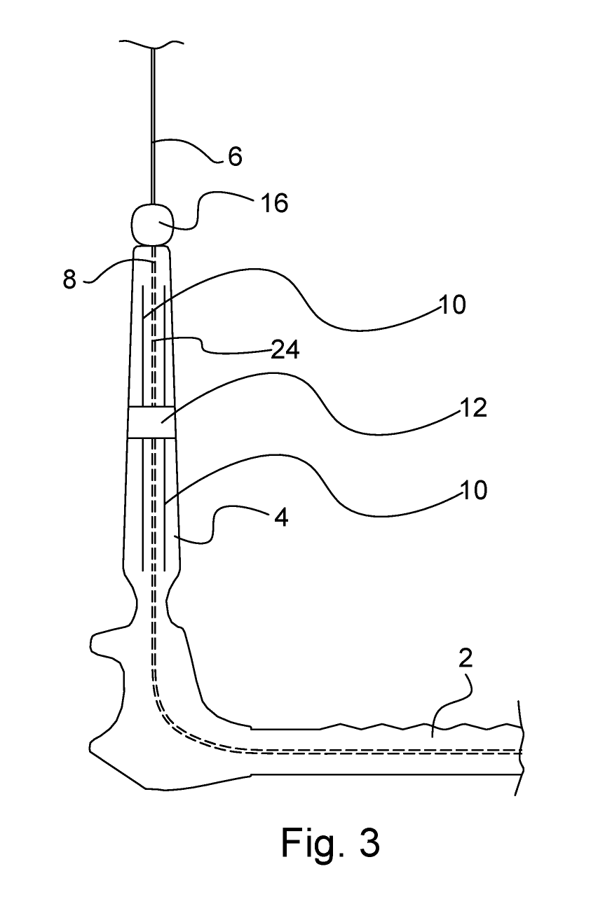

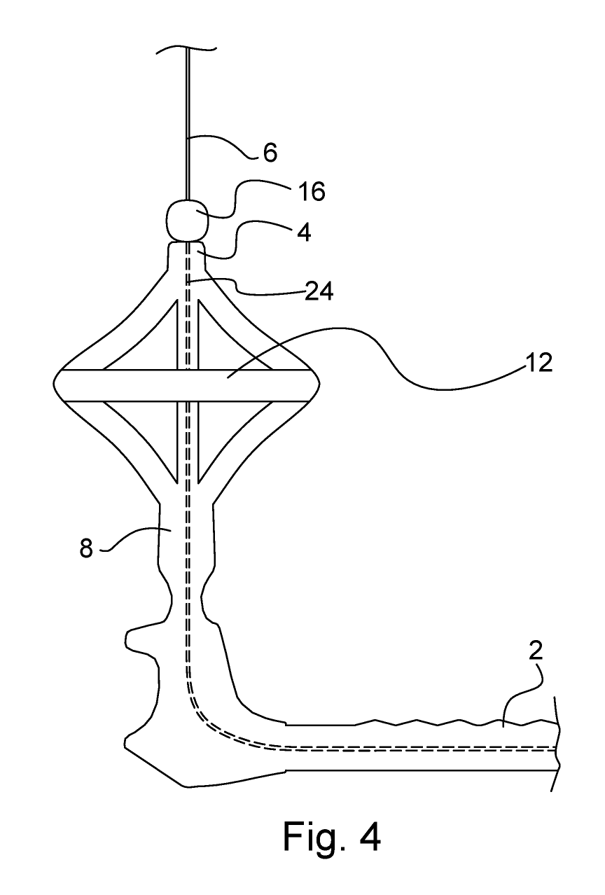

There will hereinafter be described various embodiments of bar end floats 4, and entities that will occupy the same space as the bar end float 4, that will provide a tensioning force on the trim line 24. The first embodiment of this is illustrated in FIG. 1 and FIG. 2 which disclose a bar end float 4 which is able to expand and contract under varying compression forces. Referring to FIG. 1, the default state for the bar end float is an expanded state. The bar end float 4 has slits 10 cut lengthwise which allow it to buckle and compress under load. Referring to FIG. 2, when the trim line 24 is adjusted to add power, the bar end float 4 buckles and compresses under the load from the backline leader to trim line connection 16 into a contracted state. When the trim line is adjusted to remove power, the expansion of the bar end float exerts an upward force on the trim line to back line leader connection 16. Because of this, the end of trim line 24 and the top portion of the bar end 8 move together to ensure a constant tension is maintained on the trim line 24 to prevent excess line from collecting inside the bar end float 4. It should be appreciated that an elastomeric retaining band 12 can be wrapped around the bar end float as shown in FIG. 3 and FIG. 4 to provide further resistance when pushing the trim line 24 out of the top portion of the bar end 8.

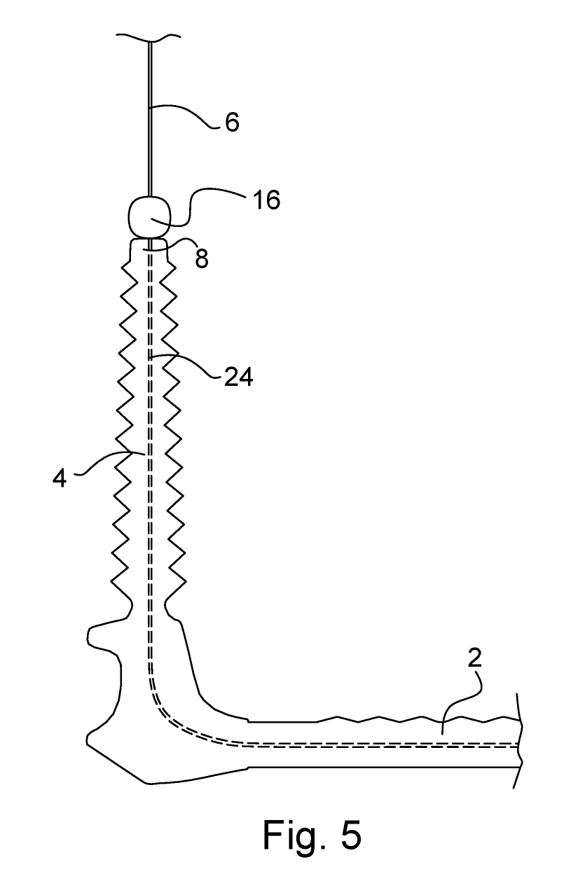

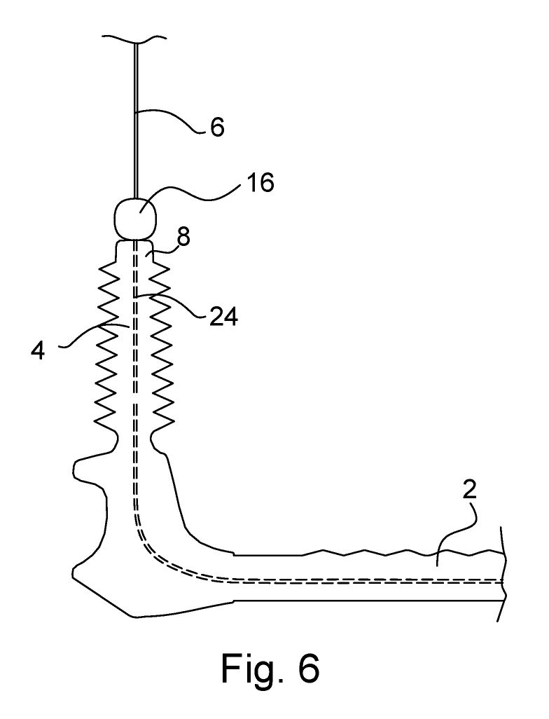

In the second embodiment of a tensioning bar end float 4, illustrated in FIG. 5 and FIG. 6, a bar end float 4 is molded in a shape similar to a bellows. This allows the float to expand and compress under varying compression loads. Referring to FIG. 5, the default state for the bar end float is an expanded state. Referring to FIG. 6, when the trim line 24 is adjusted to add power, the bar end float 4 buckles and compresses under the load from the backline leader to trim line connection 16 into a contracted state. When the trim line 24 is adjusted to remove power, the expansion of the bar end float exerts an upward force on the trim line to back line leader connection 16. Because of this, the end of trim line 24 and the top portion of the bar end 8 move together to ensure a constant tension is maintained on the trim line 24 to prevent excess line from collecting inside the kite bar 2 and the bar end float 4.

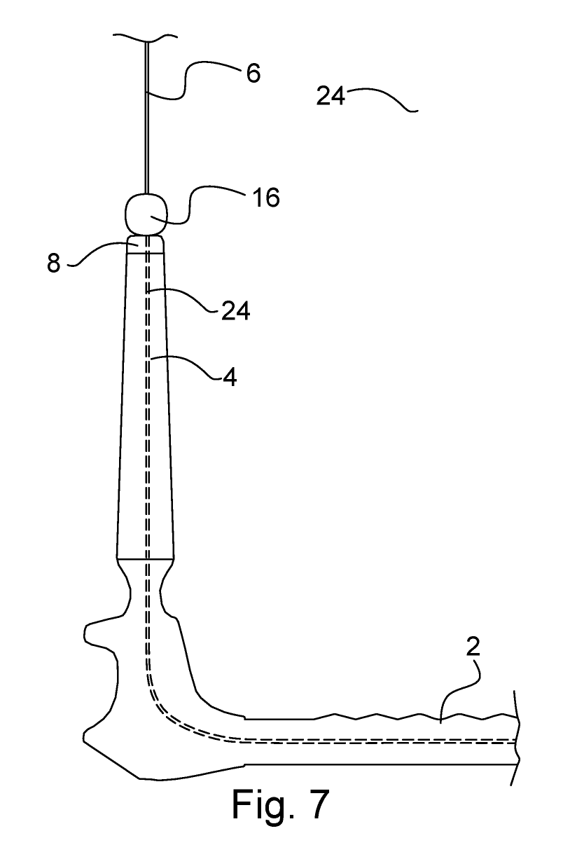

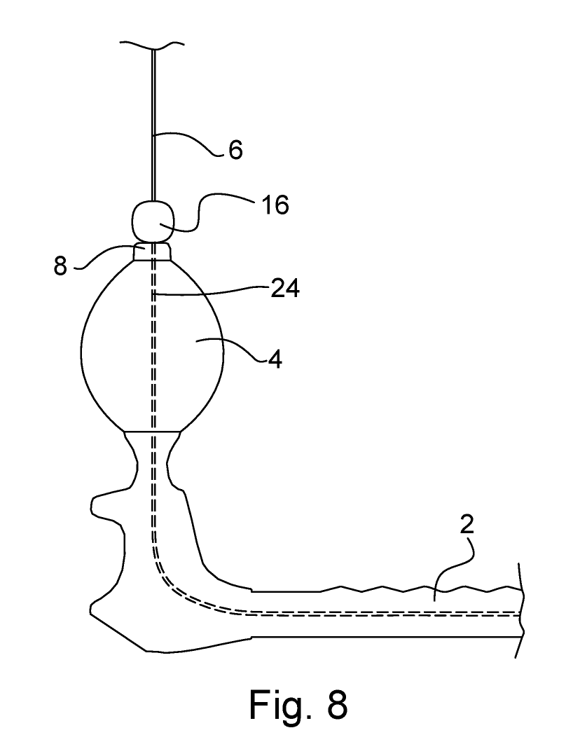

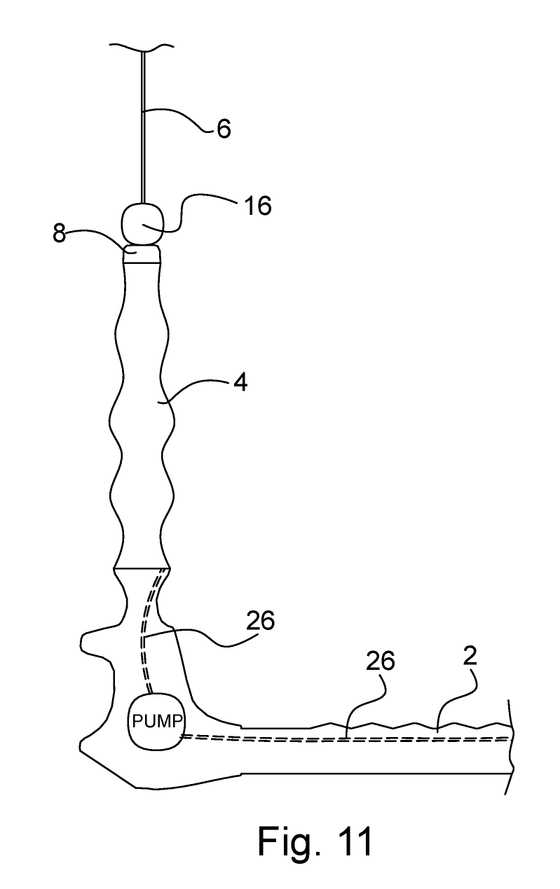

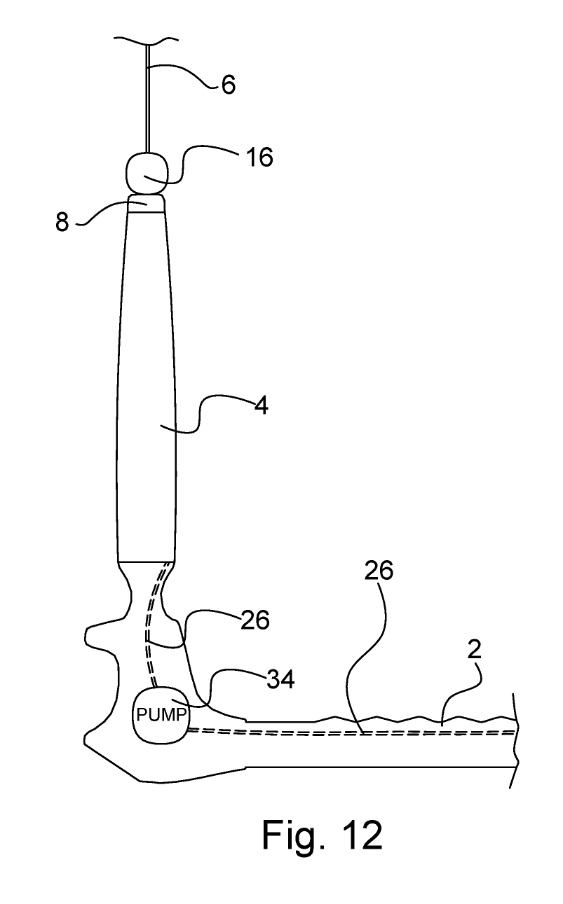

The third embodiment of a tensioning bar end float 4, illustrated in FIG. 7 and FIG. 8, a bar end float 4 contains an air-filled bladder 20. This allows the float to expand and compress under varying compression loads. Referring to FIG. 7, the default state for the bar end float is an expanded state. Referring to FIG. 8, when the trim line 24 is adjusted to add power, the compressibility of air allows the bar end float 4 to compress under the load from the backline leader to trim line connection 16 into a contracted state. When the trim line 24 is adjusted to remove power, the expansion of the bar end float exerts an upward force on the trim line to back line leader connection 16. Because of this, the end of trim line 24 and the top portion of the bar end 8 move together to ensure a constant tension is maintained on the trim line 24 to prevent excess line from collecting inside the kite bar 2 and the bar end float 4. It should be appreciated that an air pump 34 could be integrated into the bar end float itself to control the amount of air in each bar end float bladder through interior air lines 26 as illustrated in FIG. 11 and FIG. 12.

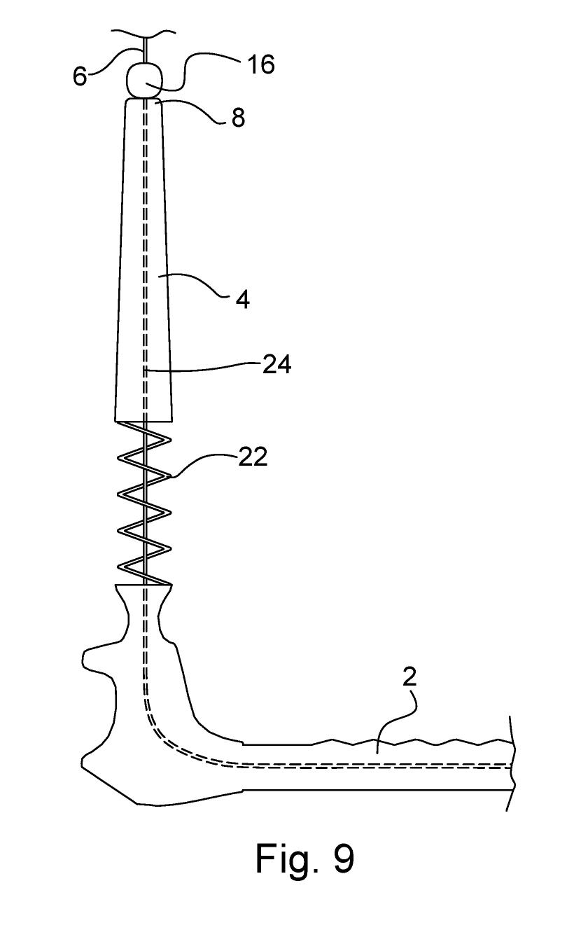

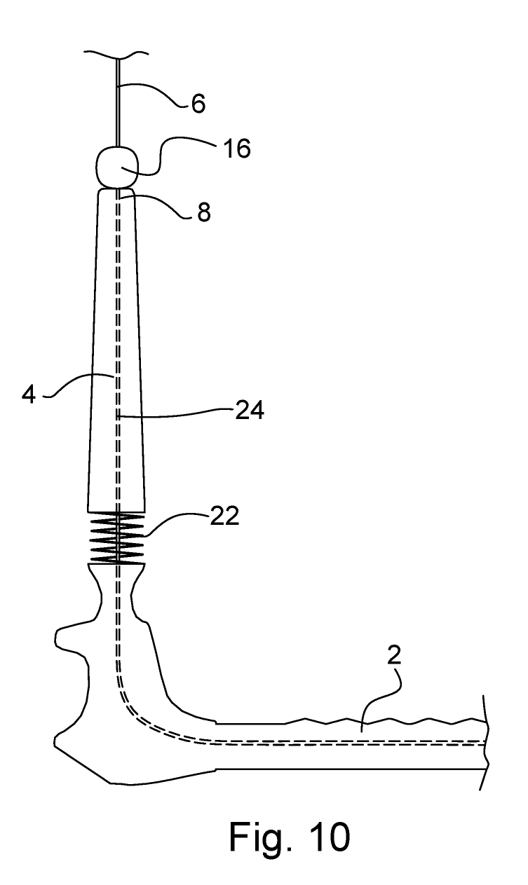

In the fourth embodiment of a tensioning bar end float 4, illustrated in FIG. 9 and FIG. 10, a compression spring 22 is positioned at the base of bar end float 4, where it meets the kite bar 2. This allows the spring to expand and compress under varying compression loads from the bar end float 4. Referring to FIG. 9, the default state for the compression spring 22 is an expanded state. Referring to FIG. 10, when the trim line 24 is adjusted to add power, the spring 22 compresses under the load from the backline leader to trim line connection 16 into a contracted state. When the trim line 24 is adjusted to remove power, spring 22 expands to exert an upward force on the trim line to back line leader connection 16. Because of this, the end of trim line 24 and the top portion of the bar end 8 move together to ensure a constant tension is maintained on the trim line 24 to prevent excess line from collecting inside the kite bar 2 and the bar end float 4.

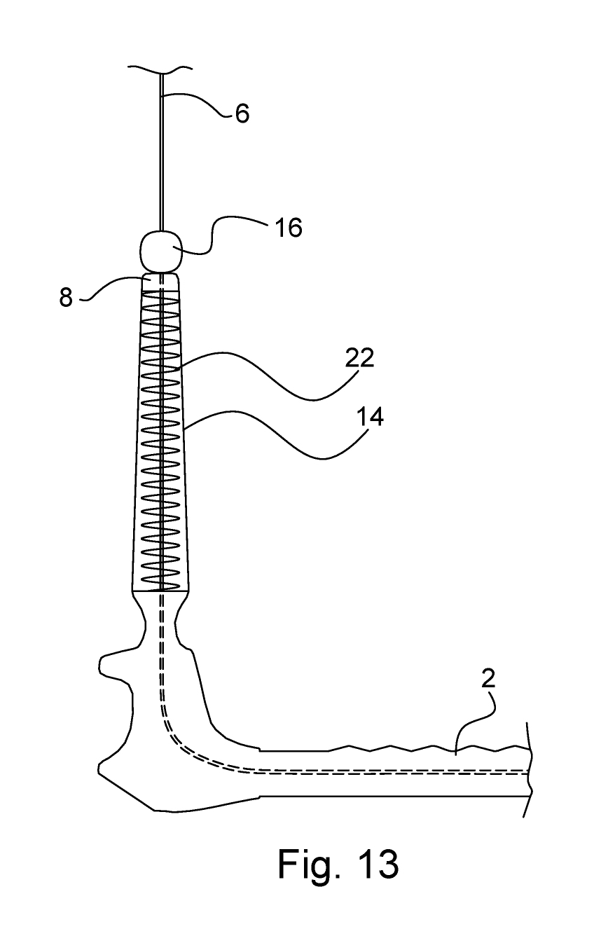

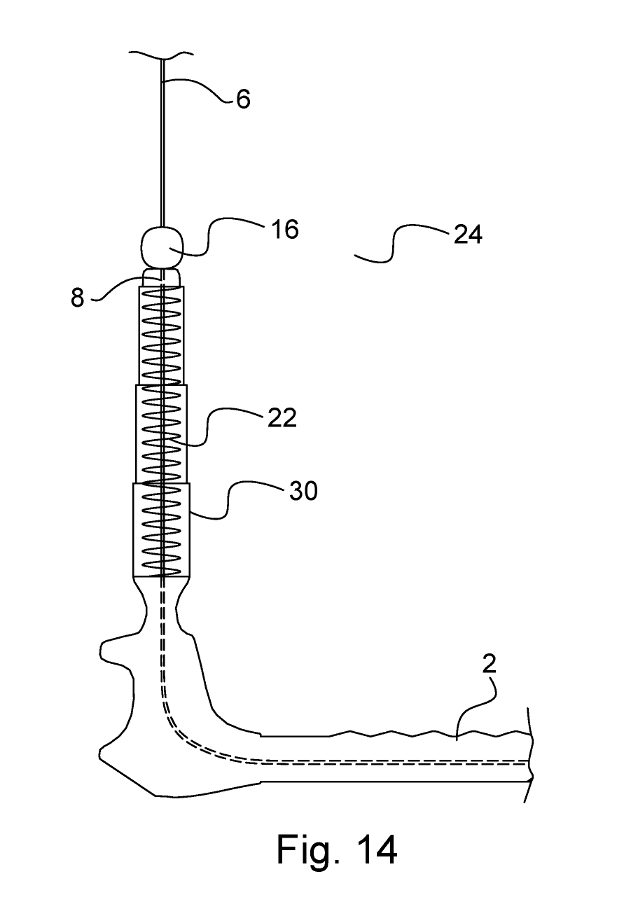

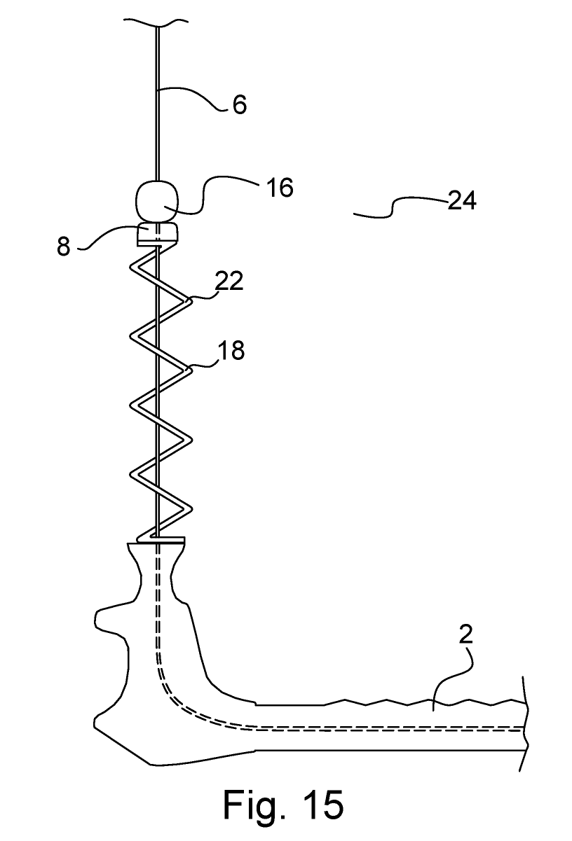

In the fifth embodiment of a tensioning bar end float 4, illustrated in FIG. 13 and FIG. 14, a compression spring 22 is located where a bar end float 4 would be located on a standard kite bar. However, this tensioning member does not provide floatation. The spring 22 is surrounded by a covering material 14. Referring to FIG. 13, the default state for the compression spring 22 is an expanded state. This embodiment operates under the same principle as the previous embodiments using a compression spring. When the trim line 24 is adjusted to add power, the spring 22 compresses under the load from the backline leader to trim line connection 16 into a contracted state. The covering material 14 will buckle to remain contained around the spring 22. When the trim line 24 is adjusted to remove power, spring 22 expands to push the top portion of the bar end 8 and backline leader to trim line connection 16 upwards which forces excess trim line 24 out of the top portion of the bar end 8. It should be appreciated that the covering material 14 can be substituted with a rigid telescoping covering material 30 shown in FIG. 14 or a foam coating 18 around the compression spring 22 as shown in FIG. 15.

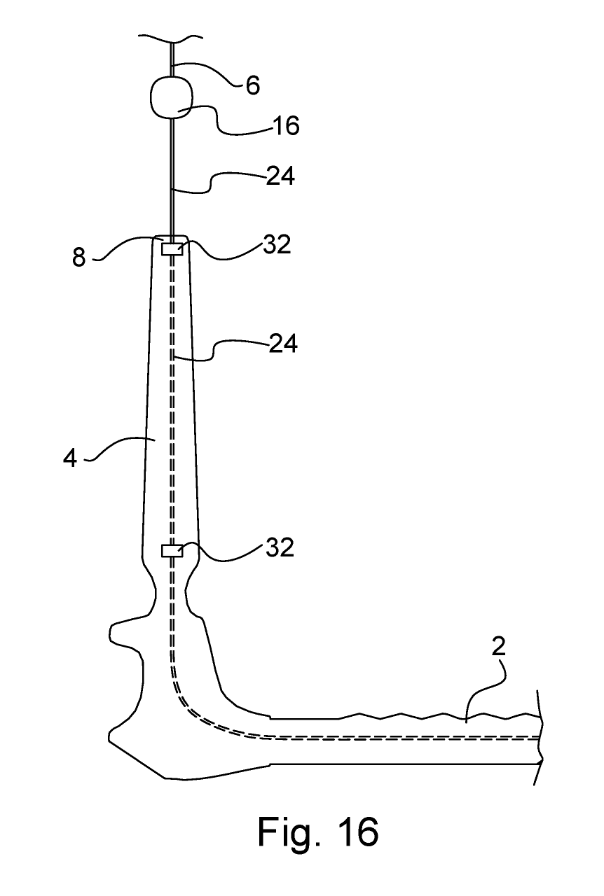

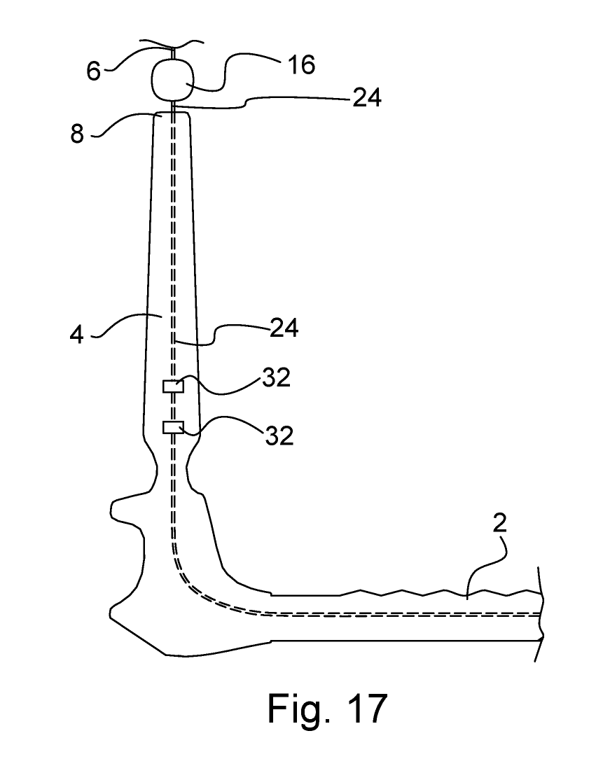

In the sixth embodiment of a tensioning bar end float 4, illustrated in FIG. 16 and FIG. 17, there are two magnets 32 contained inside the float which are oriented with the same poles facing each other to create an opposing magnetic force. One magnet 32 is attached to the top portion of the bar end 8, and the other is attached to a point on the trim line near the base of the bar end float 4. Referring to FIG. 16, the default state for the magnets is an expanded state. Referring to FIG. 17, when the trim line 24 is adjusted to add power, the magnets are pushed closer together, which increases their opposing magnetic force and creates tension on the trim line. When the trim line 24 is adjusted to remove power, the opposing magnetic force created by the magnets 32 pulls the trim line 24 upwards and out of the top portion of the bar end 8.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A kite control bar, comprising:
a line tensioning bar end float through which a back trim line passes being mounted on the kite control bar, the bar end float having an expanded default condition which maintains tension on the trim line, the bar end float contracting when a force is exerted upon the trim line.

2. The kite control bar of claim 1, wherein the bar end float is made of an open cell or closed cell foam that has resilient properties that cause it to resume its original shape.

3. The kite control bar of claim 2, wherein the foam has lengthwise slits which allow it to buckle and contract when a load is placed on the trim line.

4. The kite control bar of claim 3, wherein an elastomeric retaining band resists contraction of the bar end float and urges the bar end float to the expanded default condition.

5. The kite control bar of claim 1, wherein the bar end float is a bellows that expels air and contracts when a load is placed on the trim line; and draws air in and expands when the load is removed.

6. The kite control bar of claim 1, wherein the bar end float contains an air-filled bladder, the air-filled bladder contracting when a load is placed on the trim line and expanding when the load is removed.

7. The kite control bar claim 6, wherein an air pump is provided to regulate the amount of air in the air-filled bladder.

8. The kite control bar of claim 1, wherein the bar end float is comprised of a compression spring, the spring contracting when a load is placed on the trim line and expanding when the load is removed.

9. The kite control bar of claim 8, wherein the compression spring has a covering.

10. The kite control bar of claim 9, wherein the covering is a rigid telescopic covering.

11. The kite control bar of claim 9, wherein the covering is a foam coating.

12. The kite control bar of claim 1, wherein the end bar float is comprised of two magnets which are oriented with like poles facing each other to create an opposing magnetic force, when a force is exerted on the trim line the magnets are forced closer together, the opposing magnetic force moving the end bar float to the expanded condition when the force is removed.
